(19) United States
(12) Patent Application Publication
(10) Pub. No.: US 2016/0085471 A1
(43) Pub. Date: Mar. 24, 2016

(54) STORAGE DEVICE AND METHOD

(71) Applicants: Kabushiki Kaisha Toshiba, Tokyo (JP); Toshiba Lifestyle Products & Services Corporation, Tokyo (JP)

(72) Inventor: Emi MARUYAMA, Kunitachi Tokyo (JP)

(21) Appl. No.: 14/685,458

(22) Filed: Apr. 13, 2015

(30) Foreign Application Priority Data
Sep. 22, 2014 (JP) 2014-193061

(51) Int. Cl. G06F 3/06; G06F 12/14

(52) U.S. Cl. CPC G06F 3/0622; G06F 3/0611; G06F 3/0613; G06F 3/0679; G06F 3/0656; G06F 12/1483; G06F 2212/1052

(57) ABSTRACT

According to one embodiment, a storage device includes a hardware processor and a storage medium, wherein the hardware processor is configured to perform at least first authentication of a first electronic device to connect with the first electronic device, to perform at least second authentication of a second electronic device to connect with the second electronic device, and to receive a first content from the first electronic device after the first authentication is successfully completed, the storage medium is configured to store contents including the first content, the hardware processor is configured to transmit a second content designated by an URL transmitted by the second electronic device and stored in the storage medium after the second authentication is successfully completed, and the second content is to be reproduced on a screen of the second electronic device.

### CROSS-REFERENCE TO RELATED APPLICATIONS

This application is based upon and claims the benefit of priority from Japanese Patent Application No. 2014-193061, filed Sep. 22, 2014, the entire contents of which are incorporated herein by reference.

### FIELD

Embodiments described herein relate generally to a storage device and a method.

### BACKGROUND

Conventionally, a storage device comprising an interface connectable to an external device has been used. The storage device normally comprises a storage medium, such as a flash memory, and has a standardized portable size. The above described interface enables connection to various electronic devices, such as digital cameras, mobile phones, or digital televisions.

Further, with the spread of high-density electronic circuits and storage media, a storage device with a wireless communication interface, such as TransferJet (registered trademark) or IEEE 802.11, has been proposed. This enables other electronic devices to access data stored in a storage medium of the storage device via the wireless communication interface.

Meanwhile, in recent years, there has been proposed a technology in which digital devices are used as advertising media for displaying images and information. However, to change contents displayed on the display devices, it is necessary to provide a separate information processor in which a program that allows a user to edit the contents is installed. When the user edits the contents by the separate information processor and thereafter sends the edited contents to the digital display devices via a communication network or a storage medium, the contents are changed. Therefore, there is a large burden on the user when changing the contents displayed on the digital display devices.

### BRIEF DESCRIPTION OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary diagram illustrating a configuration example of an information display system according to an embodiment;

FIG. 2 is an exemplary diagram illustrating a configuration example of a memory card in the embodiment;

FIG. 3 is an exemplary diagram illustrating a configuration implemented by a central processing unit (CPU) by executing a control program and illustrating components stored in a storage device in the embodiment;

FIG. 4 is an exemplary sequence diagram illustrating the procedure of a content edit process in the information display system in the embodiment;

FIG. 5 is an exemplary diagram illustrating screen transition according to an edit program in the embodiment;

FIG. 6 is an exemplary diagram illustrating an example of a template selectable in a template selection screen in the embodiment;

FIG. 7 is an exemplary diagram illustrating an example of a template selectable in the template selection screen in the embodiment; and

FIG. 8 is an exemplary sequence diagram illustrating the procedure of a content display process in the information display system in the embodiment.

### DETAILED DESCRIPTION

In general, according to one embodiment, a storage device comprises a hardware processor and a storage medium, wherein the hardware processor is configured to perform at least first authentication of a first electronic device to connect with the first electronic device, to perform at least second authentication of a second electronic device to connect with the second electronic device, and to receive a first content from the first electronic device after the first authentication is successfully completed, the storage medium is configured to store contents including the first content, the hardware processor is configured to transmit a second content designated by an URL transmitted by the second electronic device and stored in the storage medium after the second authentication is successfully completed, and to the second content is to be reproduced on a screen of the second electronic device.

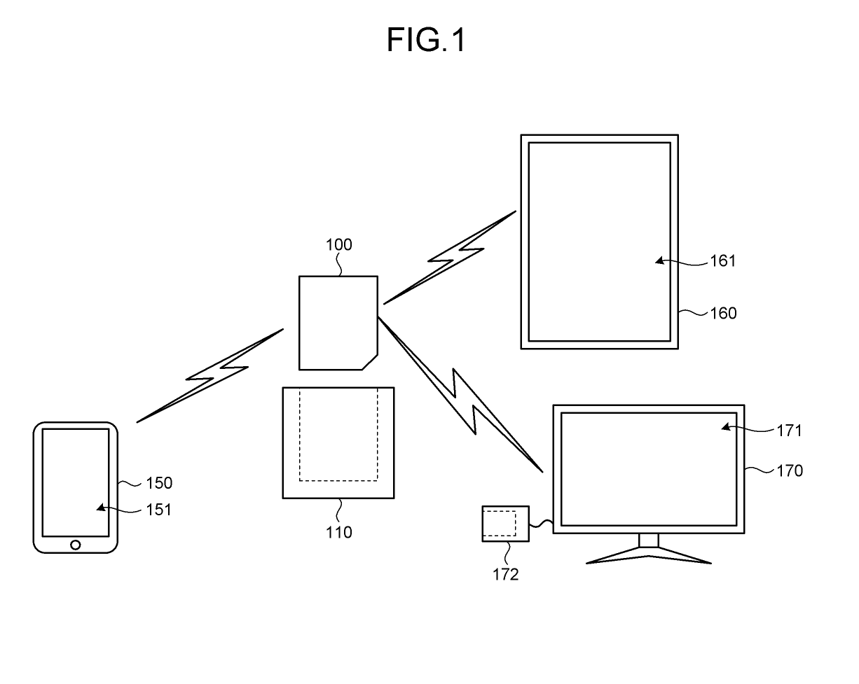

FIG. 1 is a diagram illustrating a configuration example of an information display system according to an embodiment. The information display system comprises, as illustrated in FIG. 1, a tablet terminal 150, a memory card reader 110, an information processor 160, and a digital television 170.

The memory card reader 110 enables read and write of data from and to a memory card 100 when the memory card 100 is attached thereto.

Further, the memory card reader 110 supplies power to the attached memory card 100. Therefore, when a wireless communication module is stored in the memory card 100, it is possible to transmit and receive information to and from other electronic devices without through the memory card reader 110.

The tablet terminal 150 is a terminal, which comprises a display 151, which can be carried with a user, and which stores therein a wireless communication module (not illustrated). Further, various functions can be provided if a CPU (not illustrated) installed in the tablet terminal 150 executes a program.

The information processor 160 comprises at least a display 161 and a wireless communication module (not illustrated). Further, various functions can be provided if a CPU (not illustrated) installed in the information processor 160 executes a program.

The digital television 170 comprises a wireless communication module (not illustrated) and a display 171. Further, a browser can be implemented if a CPU (not illustrated) installed in the digital television 170 executes a browser program stored in a storage module (not illustrated).

Moreover, the digital television 170 is connected to a memory card reader 172. Therefore, if a memory card (for example, the memory card 100) is attached to the memory card reader 172, the digital television 170 can access data stored in the memory card.

The memory card 100 comprises a wireless communication module and can implement a wireless access point function by using the wireless communication module. The memory card 100 can establish communication with electronic devices comprising wireless communication modules by using the wireless access point function.

In the embodiment, when the information processor 160 and the digital television 170 establish wireless communication with the memory card 100, it becomes possible to acquire content to be displayed as an advertisement or the like from the memory card 100, and display the content.

In the embodiment, content comprises image data and an hypertext markup language (HTML) file. In the HTML file, a path of an image file (a storage location in a storage) is designated and character string information is written. Therefore, it is possible to display a combination of a character string and image data as an advertisement or the like. Meanwhile, it maybe possible to display only image data as content.

Further, in the embodiment, when the tablet terminal 150 accesses the memory card 100, it is possible to edit contents that are displayed as advertisements or the like on the information processor 160 and the digital television 170.

Specifically, in a conventional digital signage system that displays an advertisement or the like, image data is edited in a separate information processor and then the image data is stored in a storage device of a server. Thereafter, the server connects to digital signage terminals (digital televisions) installed in multiple places via a public network and changes image data groups to be displayed. The above described procedure of changing the image data groups maybe available for large-scale operators, but maybe difficult for small-scale operators. In the case of small-scale operators, a user needs to directly access storage devices of the digital signage terminals to change the image data groups, resulting in increased loads.

Further, if image data already displayed on a digital signage terminal (a digital television) is to be further modified, it has been necessary to re-edit the image data by the separate information processor used for edit.

Therefore, the embodiment describes the memory card 100 that reduces loads imposed when the contents are to be changed.

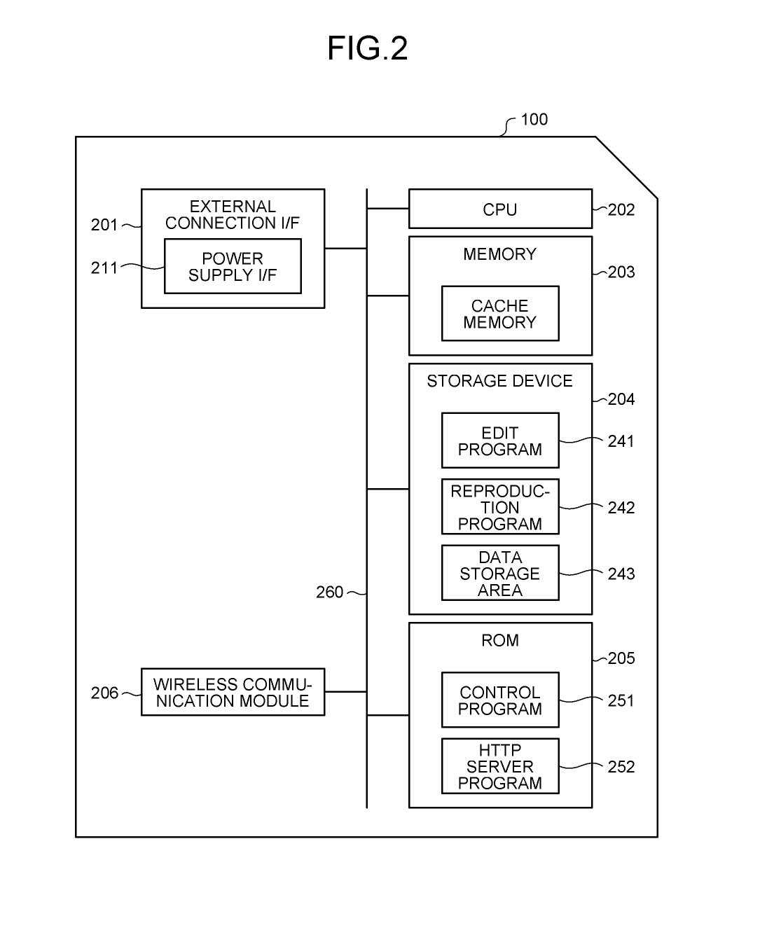

FIG. 2 is a diagram illustrating a configuration example of the memory card 100 in the embodiment. As illustrated in FIG. 2, the memory card 100 comprises an external connection interface (I/F) 201, a CPU 202, a memory 203, a storage device 204, a read only memory (ROM) 205, and a wireless communication module 206, all of which are connected to one another via a bus 260.

The memory card 100 is a storage device (for example, an secure digital (SD) memory card) with a standardized size and the standardized external connection I/F 201, and is connectable to an external device comprising an interface based on the same standard (for example, the SD standard). Further, the memory card 100 has a size that can be carried with a user.

The CPU 202 controls the entire memory card 100. Further, the CPU 202 executes programs stored in the ROM 205, and implements various functions based on the programs by using the memory 203 as a work area.

The external connection I/F 201 is a connection interface connectable to an electronic device, such as a memory card reader (for example, the memory card reader 110, the memory card reader 172, a built-in memory card slot of a digital still camera, or the like).

The external connection I/F 201 transmits and receives data to and from other electronic devices connected via memory card readers or the like, under control of the CPU 202.

The external connection I/F 201 further comprises a power supply I/F 211. The power supply I/F 211 is an I/F for supplying power to the entire memory card 100 from a memory card reader or the like connected to the external connection I/F 201. The memory card 100 can operate the CPU 202 and the like as described below by being supplied with power via the power supply I/F 211.

The memory 203 is used as a cache memory by other electronic devices for reading and writing data, as well as the work area used by the CPU 202.

The storage device 204 is provided with an edit program 241, a reproduction program 242, and a data storage area 243. The storage device 204 is configured by a non-volatile semiconductor memory, such as a flash memory. Data stored in the storage device 204 is segmented into a plurality of blocks (sectors), and data is read and written in units of blocks.

The edit program 241 is a program for editing content to be displayed on the information processor 160 or the digital television 170. In the embodiment, the edit program 241 is executable by, for example, the tablet terminal 150.

The reproduction program 242 is a program specialized to reproduce content by using a built-in browser function of a display device.

The data storage area 243 is a storage medium for storing data to be read and written by an external device.

The wireless communication module 206 is a wireless communication interface, such as TransferJet (registered trademark) or Wi-Fi (registered trademark). Further, the wireless communication module 206 enables transmission and reception of data to and from other external devices under control of the CPU 202.

The ROM 205 is provided with a control program 251 and a hypertext transfer protocol (HTTP) server program 252.

When the CPU 202 executes the HTTP server program 252, the CPU 202 controls the wireless communication module 206 and implements a wireless access point function to establish wireless connection and perform communication with other electronic devices. Therefore, an electronic device comprising a wireless communication module can directly perform wireless communication with the memory card 100.

Further, when the CPU 202 executes the HTTP server program 252, the CPU 202 controls the wireless communication module 206 and implements an HTTP server function. Therefore, it becomes possible to display content on a browser installed in an electronic device. Furthermore, it becomes possible to transmit and receive data, such as programs, by using an HTTP protocol.

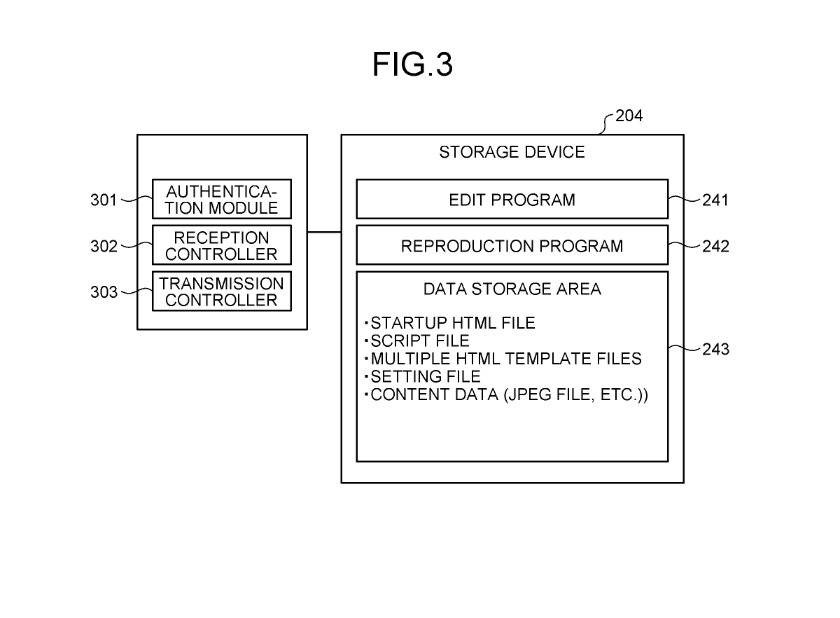

Next, a case will be described in which the CPU 202 executes the control program 251. FIG. 3 is a diagram illustrating an exemplary configuration implemented by the CPU 202 in the embodiment by executing the control program 251 and exemplary components stored in the storage device 204.

As illustrated in FIG. 3, if the CPU 202 executes the control program 251, an authentication module 301, a reception controller 302, and a transmission controller 303 are implemented.

The authentication module 301 performs authentication with an electronic device that has sent a connection request for wireless communication by using the wireless access point function, in order to connect to the electronic device. As an authentication method, any method is applicable. For example, authentication using a service set identifier (SSID) and an encryption key may be applicable.

The reception controller 302 receives data from an electronic device by using one or both of the external connection I/F 201 and the wireless communication module 206. For example, after the authentication module 301 has successfully completed authentication, the reception controller 302 receives, by using the wireless communication module 206, content or the like from an electronic device for which the authentication is successfully completed (for example, the tablet terminal 150 or the like as a first electronic device).

The transmission controller 303 transmits data to an electronic device by using one or both of the external connection I/F 201 and the wireless communication module 206. For example, after the authentication module 301 has successfully completed authentication, the transmission controller 303 transmits, by using the wireless communication module 206, content or the like stored in the data storage area 243 designated by a URL by an electronic device for which the authentication is successfully completed (for example, one or both of the information processor 160 and the digital television 170 as a second electronic device), in order to reproduce the content or the like on the electronic device.

In the embodiment, as a method of displaying content on the digital television 170 or the information processor 160, it is possible to select one of two methods.

A first method of displaying contents is a method of displaying a plurality of contents (for example, pieces of image data, such as JPEG) stored in a single folder while switching between the contents at predetermined time intervals.

A second method of displaying contents is a method of reading a script file via an HTML file when an electronic device reads the HTML file, and displaying HTML files with embedded images or character strings in a switching manner by using a function written in the script file.

To implement the second method of displaying contents, a startup HTML file, a script file, a plurality of HTML template files, a setting file, and image data to be displayed as content are used, all of which are stored in the data storage area 243.

For example, the browser of the digital television 170 accesses the script file and the setting file written in the startup HTML file by executing the startup HTML file.

In the script file, a function for switching between HTML files to be displayed, a function for implementing a change in display modes of the HTML files, and a function for generating the HTML files to be displayed from the HTML template files are written.

In the setting file, for example, a setting for displaying a plurality of contents in a switching manner in a JSON format is stored. The setting includes file names indicating respective pieces of image data to be displayed, identification information on an HTML template to be used for display as content, a switching time (display interval) of the pieces of the image data, character strings to be displayed with image data, color of letters, transparency of a background color, and a display mode (for example, fade out) for the case of changing contents.

The browser of the digital television 170 calls a function written in the script file, generates an HTML file, in which the attribute of a predetermined IMG tag is overwritten with a path name of an image file or in which a character string in a predetermined element is overwritten, from the HTML template files, and displays the HTML file, on the basis of the setting stored in the setting file. Further, after the switching time set in the setting file has elapsed, an HTML file to be displayed next is generated and displayed.

For example, when the tablet terminal 150 edits content, the authentication module 301 performs authentication of the tablet terminal 150. Subsequently, the reception controller 302 receives at least the setting file and image data to be displayed as content from the tablet terminal 150 for which the authentication module 301 has successfully completed the authentication. In this case, the reception controller 302 may receive any one or more of the HTML template files, the script file, and the startup HTML file from the tablet terminal 150.

Subsequently, the transmission controller 303 transmits the image data, the startup HTML file, the script file, the HTML template files, the setting file, and the like stored in the storage device 204 designated by a URL by the electronic device (for example, the tablet terminal 150).

Therefore, an electronic device serving as a transmission destination can display contents including character string information and image data in a switching manner.

Meanwhile, in the embodiment, all of functions needed to display contents are stored in the memory card 100.

For example, the storage device 204 of the memory card 100 stores therein the edit program 241 executable by the tablet terminal 150, in order to edit data needed to display contents. Therefore, for example, when a user wants to edit content, and if an electronic device (for example, the tablet terminal 150) of the user can access the memory card 100 with or without a wire, it is possible to edit the content by the electronic device. Meanwhile, the memory card 100 needs to be attached to the memory card reader 110 and supplied with at least power.

When the tablet terminal 150 accesses the memory card 100 by using the wireless access point function of the memory card 100, the authentication module 301 performs authentication with at least the tablet terminal 150 in order to connect to the tablet terminal 150.

The transmission controller 303 of the memory card 100 appropriately controls transmission of the edit program 241 to the tablet terminal 150 for which the authentication is successfully completed, by using the wireless communication module 206. Therefore, the user can perform edit by using the tablet terminal 150 in order to display content.

For another example, the storage device 204 of the memory card 100 stores therein the reproduction program 242 executable by the information processor 160 in order to reproduce contents. Therefore, for example, when a user wants to reproduce content, and if an electronic device (for example, the information processor 160) comprising a display can access the memory card 100 with or without a wire, it is possible to reproduce the content by the electronic device.

When the information processor 160 accesses the memory card 100 by using the wireless access point function of the memory card 100, the authentication module 301 performs authentication with at least the information processor 160 in order to connect to the information processor 160.

The transmission controller 303 of the memory card 100 appropriately controls transmission of the reproduction program 242 to the information processor 160 for which the authentication is successfully completed, by using the wireless communication module 206. If the information processor 160 executes the reproduction program 242, it becomes possible to display the content.

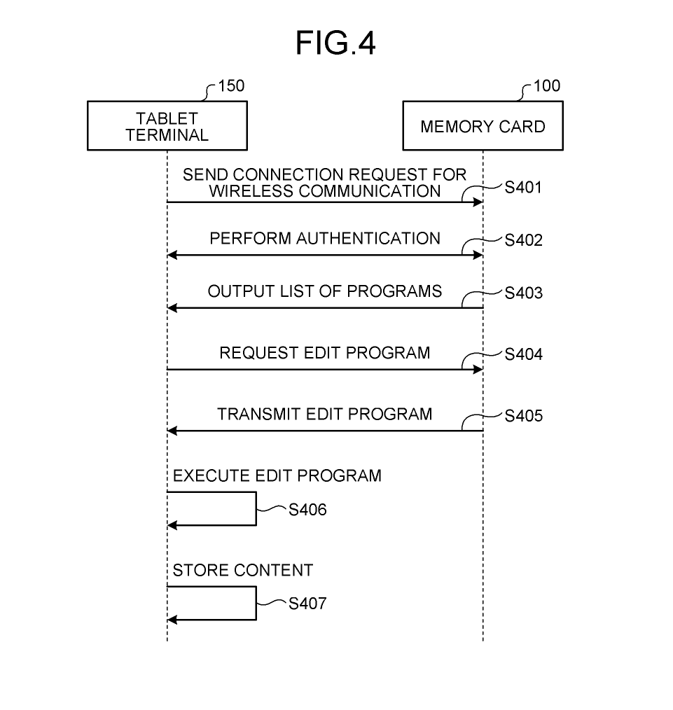

Next, a content edit process in the information display system of the embodiment will be described. FIG. 4 is a sequence diagram illustrating the procedure of the above described process in the information display system in the embodiment.

First, the tablet terminal 150 sends a connection request for wireless communication by using the wireless access point function of the memory card 100 (S401). According to the connection request for wireless communication, the tablet terminal 150 and the memory card 100 perform authentication, such as authentication using an SSID, to perform wireless communication (S402). Consequently, wireless communication between the tablet terminal 150 and the memory card 100 is established.

Subsequently, the transmission controller 303 of the memory card 100 outputs a list of programs to the tablet terminal 150 (S403). Accordingly, a user can select a program downloadable to the tablet terminal 150. In the sequence diagram, the user selects the edit program 241 to edit contents.

Subsequently, the tablet terminal 150 sends a request for download of the edit program 241 to the memory card 100 (S404).

Accordingly, the transmission controller 303 of the memory card 100 transmits the edit program 241 to the tablet terminal 150 (S405). In other words, the tablet terminal 150 downloads the edit program 241 from the memory card 100.

After transmission of the edit program 241 is completed, the tablet terminal 150 installs and executes the edit program 241 (S406).

Subsequently, the tablet terminal 150 stores the content by the edit program 241 (S407).

In the embodiment, through the above described procedure, it becomes possible to edit contents if there is an electronic device (for example, the tablet terminal 150) that can perform wireless communication with the memory card 100.

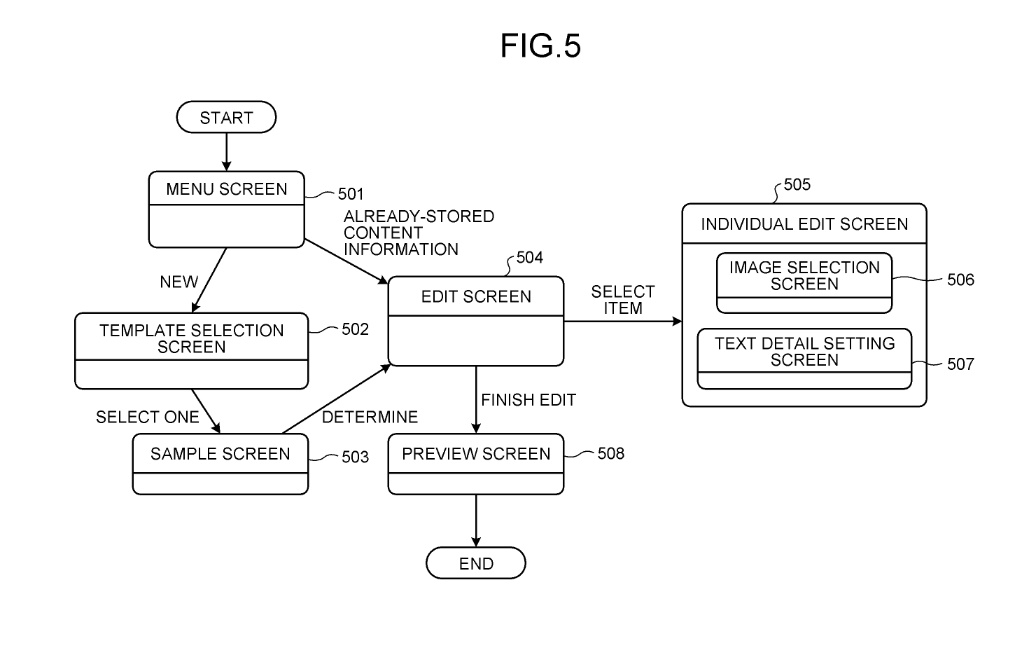

Next, the edit program 241 executed by the tablet terminal 150 will be described. FIG. 5 is a diagram illustrating screen transition according to the edit program 241.

As illustrated in FIG. 5, when the edit program 241 is executed, a menu screen 501 is displayed on the display 151 of the tablet terminal 150.

In the menu screen 501, it is possible to select already-stored content information or new creation. The already-stored content information is a data group needed to display a plurality of contents (for example, image data or character strings) in a switching manner, and includes at least a plurality of pieces of image data and the setting file.

If a user selects the already-stored content information, the screen switches to an edit screen 504. If the new creation is selected, the screen switches to a template selection screen 502.

In the template selection screen 502, a template for displaying content is selected. In the embodiment, one of templates stored in the edit program 241 is selected. The template is selected according to a display of an electronic device on which the content is to be displayed. For example, the user selects a template according to whether the electronic device is a longitudinal type or a transverse type. Further, the user selects a template according to relative arrangement of character strings and image data. Meanwhile, the number of selectable templates is determined according to embodiments.

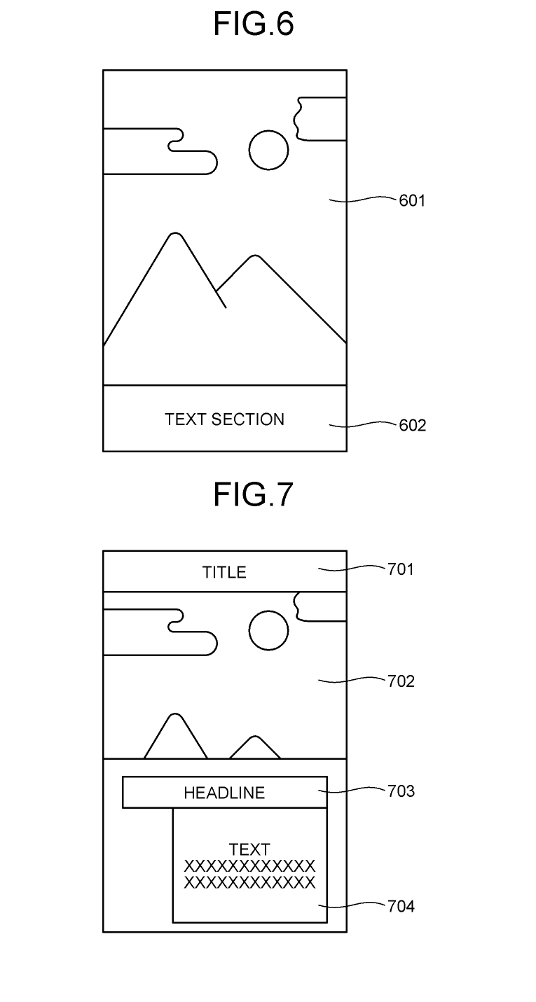

FIG. 6 is a diagram illustrating an example of the template selectable in the template selection screen 502. In the example illustrated in FIG. 6, the template comprises an area 601 in which content, such as an image, is allocated and a text section 602 in which a character string is written by a user.

FIG. 7 is a diagram illustrating an example of the template selectable in the template selection screen 502. In the example illustrated in FIG. 7, the template comprises a title area 701 in which a title of content is written by a user, an area 702 in which content, such as an image, is allocated, a header 703 in which a headline of text is written by the user, and a text section 704 in which the text is written.

As described above, it is possible to select a template for displaying content on the digital television 170 or the information processor 160. Meanwhile, in the examples illustrated in FIG. 6 and FIG. 7, templates for the longitudinal type are illustrated, however, it is possible to select a template for the transverse type. A user selects a template according to an electronic device on which content is to be displayed, details of the content, or information that the user wants to display. Meanwhile, while the embodiment describes an example in which a single template is selected, it may be possible to select and mix a plurality of templates.

While a single piece of image data is arranged in a single screen in the examples illustrated in FIG. 6 and FIG. 7, it maybe possible to arrange a plurality of pieces of image data.

If a user selects a template on the template selection screen 502, the screen switches to a sample screen 503 according to the edit program 241. If the user visually checks and accepts the sample screen 503, the edit program 241 accepts an operation of determining the template. Consequently, the screen switches to the edit screen 504.

The edit screen 504 is an edit screen for displaying contents in a switching manner, in other words, for setting a slideshow. In the edit screen, it is possible to set the number of contents and a display interval between the contents. The edit screen 504 displays a list of pages that are to be displayed as the contents. If the user selects content (page) to be edited from the list of the pages, the screen switches to an individual edit screen 505.

The individual edit screen 505 comprises an image selection screen 506 and a text detail setting screen 507 in order to edit content (page).

The image selection screen 506 is a screen for selecting image data to be displayed as content. It maybe possible to select image data captured by the tablet terminal 150, image data stored in the tablet terminal 150, or image data acquired via a public network.

The text detail setting screen 507 is a screen for inputting a character string to be displayed as content. In the screen, a character string input area corresponding to the selected template is arranged. Therefore, the user can input a character string appropriate for the selected template. Further, the text detail setting screen 507 accepts a setting of a color of a background of characters or image data to be displayed as a background.

If the user performs an operation of finishing the edit in the edit screen 504, the screen switches to a preview screen 508.

The preview screen 508 displays a slideshow based on content information, for which the edit has been completed. After the user confirms the content on the preview screen 508, the content information is stored. Consequently, the edit program 241 stores therein, as components of the content information, image data and the setting file storing information that is needed to display contents in a switching manner. Meanwhile, the character string input in the text detail setting screen 507 is stored in the setting file together with other settings. The image data and the setting file stored as above are appropriately transmitted to the memory card 100.

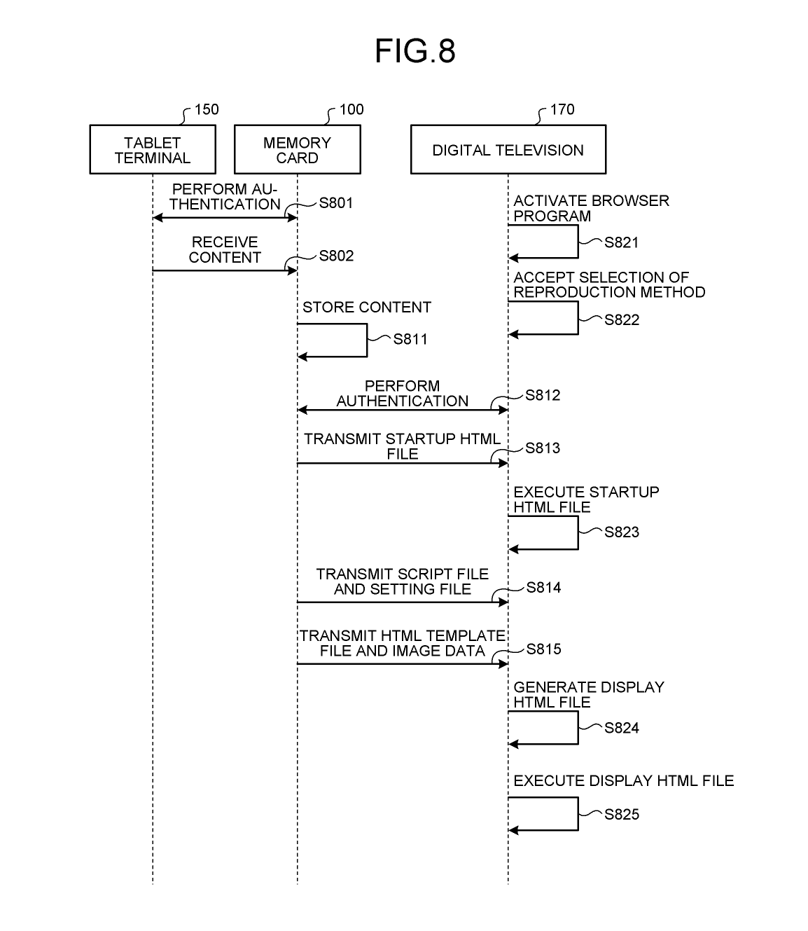

Next, a content display process in the information display system of the embodiment will be described. FIG. 8 is a sequence diagram illustrating the procedure of the above described process in the information display system in the embodiment.

First, the tablet terminal 150 sends a connection request for wireless communication by using the wireless access point function of the memory card 100. Accordingly, the authentication module 301 of the memory card 100 connects to the tablet terminal 150 and performs authentication, such as authentication using an SSID, to perform wireless communication (S801).

Subsequently, the reception controller 302 receives, as contents, at least image data and the setting file from the tablet terminal 150 for which the authentication is successfully completed (S802).

Then, the reception controller 302 stores the image data and the setting file, which are the received contents, in the data storage area 243 of the storage device 204 (S811).

Meanwhile, the digital television 170 activates the browser program (S821). Accordingly, the browser is implemented in the digital television 170. In the case of the information processor 160, the reproduction program received from the memory card 100 is activated.

Subsequently, the browser of the digital television 170 accepts a selection of a content reproduction method from a user (S822). As the content reproduction method, a method of switching between pieces of image data in the same folder or a method of using HTML files is selectable. In the sequence diagram, it is assumed that the method of using HTML files is selected.

Then, the digital television 170 sends a connection request for wireless communication by using the wireless access point function of the memory card 100. Accordingly, the authentication module 301 of the memory card 100 connects to the digital television 170 and performs authentication, such as authentication using an SSID, to perform wireless communication (S812).

Subsequently, the transmission controller 303 transmits a startup HTML file by using an HTTP protocol according to a request for transmission of the startup HTML file designated by an URL by the browser of the digital television 170 for which the authentication is successfully completed (S813). Meanwhile, it is assumed that a file name of the startup HTML file is determined in advance. Consequently, the browser can read the startup HTML file at the time of establishing the wireless communication.

Then, the browser of the digital television 170 executes the startup HTML file (S823).

The browser of the digital television 170 requests the memory card 100 to transmit the script file and the setting file, which are written in the startup HTML file, so that the transmission controller 303 of the memory card 100 transmits the script file and the setting file by using an HTTP protocol according to the request for transmission designated by the URL by the browser of the digital television 170 (S814). Further, the browser that has read the script file and the setting file sends a request for an HTML template file and image data according to settings indicated in the setting file.

Accordingly, the transmission controller 303 of the memory card 100 transmits the HTML template file and the image data by using an HTTP protocol in response to the request for transmission designated by the URL by the browser of the digital television 170 (S815).

Subsequently, the browser of the digital television 170 generates a display HTML file for displaying the received image data and a character string stored in the setting file, based on the settings written in the setting file by using the functions indicated in the script file (S824).

The browser of the digital television 170 displays the generated display HTML file (S825). Subsequently, when a switching time set in the setting file has elapsed, the browser of the digital television 170 repeats the processes at 5824 and S825 in order to display a next display HTML file.

Through the above described processing procedure, it becomes possible to display content edited by the tablet terminal 150 on the digital television 170.

In the above described processing procedure, an example has been described, in which content is transmitted and received by using wireless communication and the content is displayed on the digital television 170. However, the embodiment is not limited to the example in which content is transmitted and received by using wireless communication.

For example, it may be possible to transmit content by using the external connection I/F 201 of the memory card 100. This may be applied when the memory card 100 is attached to the memory card reader 172 of the digital television 170.

In this case, if the transmission controller 303 of the memory card 100 is connected to the digital television 170 with a wire via the memory card reader 172 connected to the external connection I/F 201, a plurality of pieces of image data, which are stored as a plurality of contents in a single folder in the data storage area 243, are transmitted to the digital television 170 such that the pieces of image data can be reproduced repeatedly.

Meanwhile, any types of storage devices are applicable to the memory card 100. For example, FlashAir (registered trademark) may be used.

In the above described embodiment, the above described configuration of the memory card 100 enables to easily update and change contents.

Conventionally, contents in display devices placed in various places tend to be updated via a public communication line. In this case, it may be possible for operators to cause a server storing updated contents to collectively update the contents in the display devices placed in various places. However, it may be difficult for small-scale operators to introduce the system as described above.

Therefore, in the embodiment, the memory card 100 functions as a server that stores therein contents. Specifically, a user carries the memory card 100 that stores therein contents edited by the tablet terminal 150, and moves to an electronic device whose contents are to be updated. Accordingly, when the electronic device and the memory card 100 perform authentication, and thereafter, wireless communication is automatically connected, the contents can be updated automatically. Consequently, it becomes possible to reduce loads on the user when updating contents.

Moreover, the various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A storage device comprising an access point function configured to establish wireless connection and communicate with other electronic devices, the storage device comprising:
a hardware processor; and
a storage medium, wherein
the hardware processor is configured to perform at least first authentication of a first electronic device to connect with the first electronic device, to perform at least second authentication of a second electronic device to connect with the second electronic device, and to receive a first content from the first electronic device after the first authentication is successfully completed,
the storage medium is configured to store contents including the first content,
the hardware processor is configured to transmit a second content designated by an URL transmitted by the second electronic device and stored in the storage medium to the second electronic device after the second authentication is successfully completed, and
the second content is to be reproduced on a screen of the second electronic device.

2. The storage device of claim 1, wherein
the storage medium is configured to store therein a plurality of the first contents, a plurality of the second contents and setting information for switching the plurality of the second contents with other plurality of the second contents, and
the hardware processor is configured to transmit the setting information and the plurality of the second contents to the second electronic device.

3. The storage device of claim 2, wherein
the storage medium is further configured to store therein a script to change a display mode of the plurality of the second contents to be displayed on the screen of the second electronic device, and
the hardware processor is configured to transmit the script to the second electronic device.

4. The storage device of claim 3, wherein
the hardware processor is configured to receive the plurality of the first contents and the setting information for changing a display mode of at least one piece of the plurality of the second contents by using the script, from the first electronic device after the first authentication is successfully completed, and
the storage medium is configured to store therein the plurality of the first contents and the setting information received by the receiver.

5. The storage device of claim 2, wherein
the storage medium is further configured to store therein an edit program that is executable by the first electronic device to edit the setting information, and
the hardware processor is configured to transmit the edit program to the first electronic device.

6. The storage device of claim 1, wherein
the storage medium is further configured to store therein a reproduction program that is executable by the second electronic device to reproduce the second content, and
the hardware processor is configured to transmit the reproduction program to the second electronic device.

7. The storage device of claim 1, further comprising:
a connection interface connectable with an external device, wherein
when the connection interface is connected with the external device and a wire connection is established via the external device to the second electronic device, the hardware processor is configured to transmit a plurality of pieces of image information, which are stored as a plurality of the second contents in a single folder in the storage medium, to the second electronic device repeatedly for reproducing the information.

8. The storage device of claim 1, further comprising:
a connection interface connectable with an external device, wherein
the external device connected with the connection interface is configured to supply power to the storage device.

9. A method performed by a storage device comprising an access point function to establish a wireless connection and communicate with other electronic devices, the method comprising:
performing at least first authentication of a first electronic device to connect with the first electronic device;
performing at least second authentication of a second electronic device to connect with the second electronic device;
receiving a first content from the first electronic device after the first authentication is successfully completed;
storing contents including the first content in a storage medium; and
transmitting a second content designated URL transmitted by the second electronic device and stored in the storage medium to the second electronic device after the second authentication is successfully completed, wherein
the second content is to be reproduced on a screen of the second electronic device.

10. The method of claim 9, further comprising:
Storing a plurality of the first contents and a plurality of the second contents in the storage medium and setting information for switching the plurality of the second contents with other plurality of the second contents; and
transmitting the setting information and the plurality of the second contents to the second electronic device.

11. The method of claim 10, further comprising:
storing a script in the storage medium to change display a mode of the plurality of the second contents to be displayed on the screen of the second electronic device; and
transmitting the script to the second electronic device.

12. The method of claim 11, further comprising:
receiving the plurality of the first contents and the setting information for changing a display mode of at least one piece of the plurality of the second contents by using the script, from the first electronic device after the first authentication is successfully completed; and
storing the plurality of the first contents in the storage medium and the setting information received at the receiving.

13. The method of claim 10, further comprising:
storing, in the storage medium, an edit program that is executable by the first electronic device to edit the setting information; and
transmitting the edit program to the first electronic device.

14. The method of claim 9, further comprising:
storing, in the storage medium, a reproduction program that is executable by the second electronic device to reproduce the plurality of the second contents; and
transmitting the reproduction program to the second electronic device.

15. The method of claim 9, wherein
the storage device further comprises a connection interface connectable with an external device, wherein
when the connection interface is connected with the external device and a wire connection is established via the external device to the second electronic device, a plurality of pieces of image information, which are stored as a plurality of the second contents in a single folder in the storage medium, are transmitted to the second device repeatedly for reproducing the information.
